(19) United States
(12) Patent Application Publication
(10) Pub. No.: US 2025/0353148 A1
(43) Pub. Date: Nov. 20, 2025

(54) IMPACT TOOL ASSEMBLY

(71) Applicant: STORM PNEUMATIC TOOL CO., LTD., Taichung City (TW)

(72) Inventor: Yung Yung SUN, Taichung City (TW)

(21) Appl. No.: 18/664,537

(22) Filed: May 15, 2024

(51) Int. Cl. B25B 21/02; B25B 23/00

(52) U.S. Cl. CPC B25B 21/02; B25B 23/0035

(57) ABSTRACT

An impact tool assembly includes a power-driven impact tool, a connector, and a tool head. The power-driven impact tool has an inner tubular member. The inner tubular member has a chamber therein. A movable impact block is provided in the chamber. One end of the inner tubular member has a hexagonal positioning hole. The connector has one end formed with a coupling portion and another end integrally formed with an extension section and an insertion section. The tool head is rotatably connected to the coupling portion. The insertion section is inserted and engaged in the positioning hole for connecting the connector and the impact tool together and restricting the connector from rotating.

### FIELD OF THE INVENTION

The present invention relates to a power-driven impact tool, and more particularly to an impact tool assembly able to unscrew a threaded element that is tightly stuck on a workpiece.

### BACKGROUND OF THE INVENTION

Threaded elements such as nuts, if locked onto a workpiece for a long time without being removed, may be stuck tightly on the workpiece due to rust or thermal expansion and contraction, making it difficult to remove the nuts. It is required to use a hand-held impact tool for unscrewing the nuts. For a conventional hand-held impact tool used for disassembling threaded elements, a driver or socket bit is coupled to the operating end of the hand-held impact tool. When in use, the user's one hand holds the grip of the hand-held impact tool, and then the driver or socket bit is attached to the threaded element, while the other hand holds a hammer to repeatedly hammer the distal end of the grip of the hand-held impact tool. The vibration generated by hammering causes the tool to rotate at a predetermined angle, which gradually unscrews the stuck threaded element.

However, in practice, the user has to hold the hand-held impact tool with one hand and holds the hammer with the other hand for performing the hammering action. In addition to being time-consuming and labor-intensive to use, manual hammering is prone to hitting the user's hand accidentally. This problem has existed for a long time, but so far there is no solution. It has become a long-standing problem in this technical field.

In addition, the conventional hand-held impact tool also lacks a reasonable mounting mechanism. As a result, it cannot be directly mounted on a power-driven impact tool (such as a pneumatic impact tool). Although there are many power-driven impact tools on the market, there is no power-driven impact tool used for unscrewing a threaded element that is tightly stuck on a workpiece. Therefore, it is necessary to further improve the existing technology to solve the above problems.

### SUMMARY OF THE INVENTION

The primary object of the present invention is to provide an impact tool assembly able to unscrew a threaded element that is tightly stuck on a workpiece.

In order to achieve the foregoing object, the impact tool assembly provided by the present invention comprises a power-driven impact tool, a connector, and a tool head.

The power-driven impact tool has a grip. The grip has an inner tubular member therein. A chamber is formed inside the inner tubular member. An impact block is provided in the chamber. The impact block is driven by an external power to move back and forth in the chamber. One end of the inner tubular member has a hexagonal positioning hole communicating with the chamber. The positioning hole is non-circular and has six engaging surfaces.

The connector has one end formed with an enlarged coupling portion and another end integrally formed with an extension section and an insertion section that extend in a direction opposite to the coupling portion and have an outer diameter less than that of the coupling portion. An annular slope is integrally connected between the coupling portion and the extension section. The annular slope gradually tapers toward the extension section. A circular curved section is formed at an intersection of the annular slope and the extension section. A total length of the extension section and the insertion section is greater than a length of the coupling portion. The insertion section of the connector is inserted into the positioning hole. The insertion section is a hexagonal post corresponding in shape to the positioning hole, thereby restricting the connector from rotating.

The tool head is rotatably connected to the coupling portion. The tool head has a head portion extending out of the coupling portion. The head portion is in the form of a quadrangular post for connecting a socket bit. The coupling portion is expanded outward to form an accommodating groove therein. The accommodating groove has an opening. The tool head further has a body portion inserted in the accommodating groove. The coupling portion has an annular recess section. Two opposite sides of the annular recess section each have an inclined groove. A spring is provided in the accommodating groove. Two ends of the spring are against a bottom of the accommodating groove and the body portion of the tool head, respectively, for pushing the tool head. A pin is inserted into the body portion of the tool head via the inclined groove of the coupling portion. Two ends of the pin are inserted in the inclined grooves of the two opposite sides of the annular recess section of the coupling portion, respectively. A bushing is fitted on the annular recess section to cover the inclined grooves and the pin.

Preferably, a front end of the inner tubular member has a socket. When the insertion section of the connector is inserted into the positioning hole, the extension section is inserted into the socket. The socket has a connecting portion that is in contact with the extension section. In a preferred embodiment, the socket is integrally formed with the front end of the inner tubular member. The socket is in the form of a hollow tube extending out of the grip. The connecting portion is composed of a quick-release joint. The connecting portion includes a collar and a plurality of beads located in the collar and partially extending into the socket. The insertion section and the extension section are held and supported by the positioning hole and the beads of the connecting portion, respectively.

### BRIEF DESCRIPTION OF THE DRAWINGS

FIG. 1 is an exploded view of the present invention;

FIG. 2 is an assembled view of the present invention;

FIG. 3 is a perspective view of the present invention;

FIG. 4 is a cross-sectional view of the present invention; and

FIG. 5 is a partial, enlarged cross-sectional view of the present invention.

### DETAILED DESCRIPTION OF THE PREFERRED EMBODIMENTS

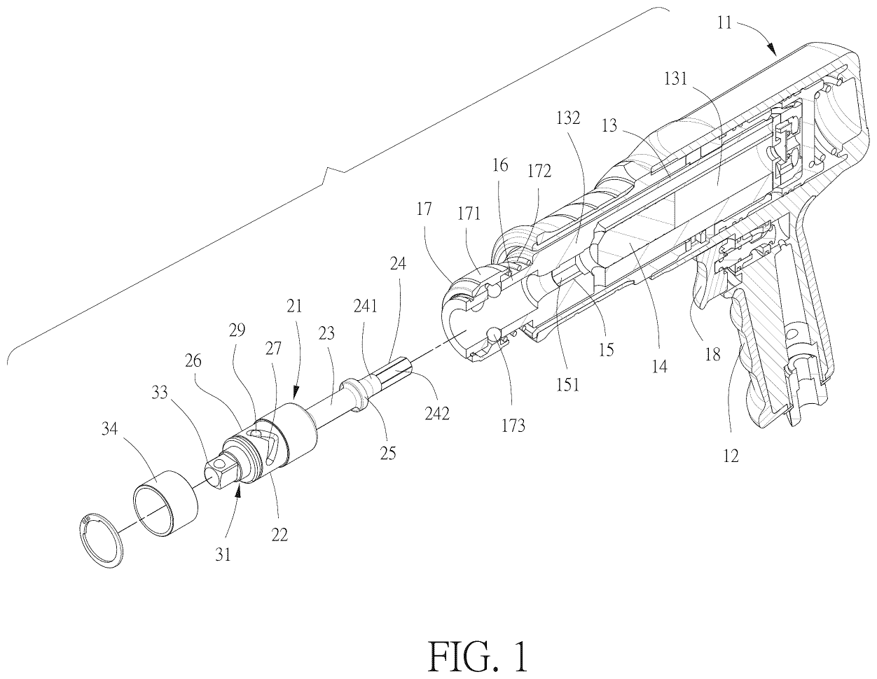

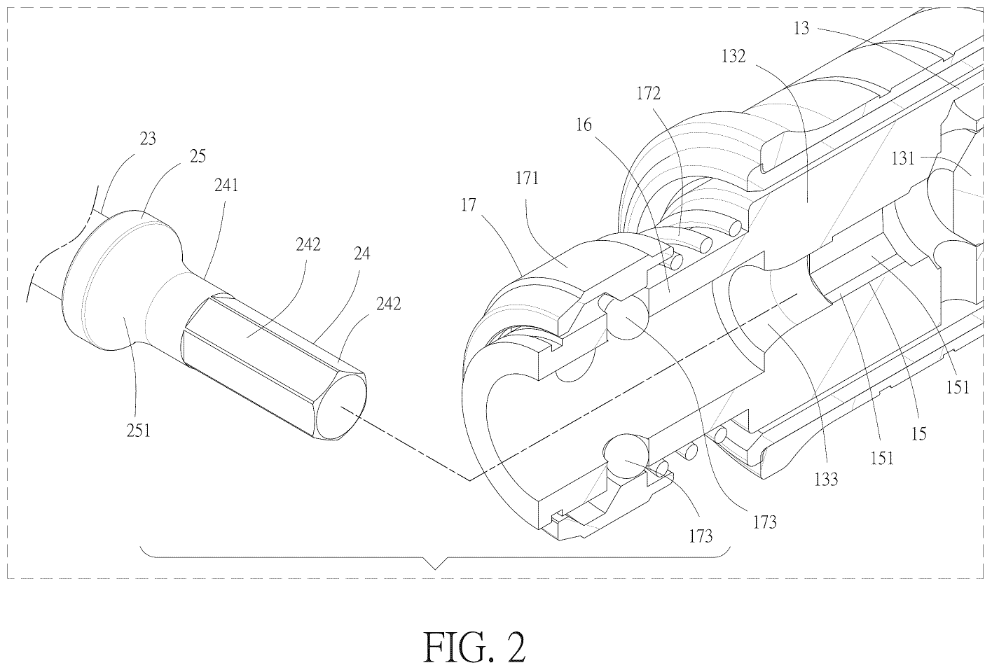

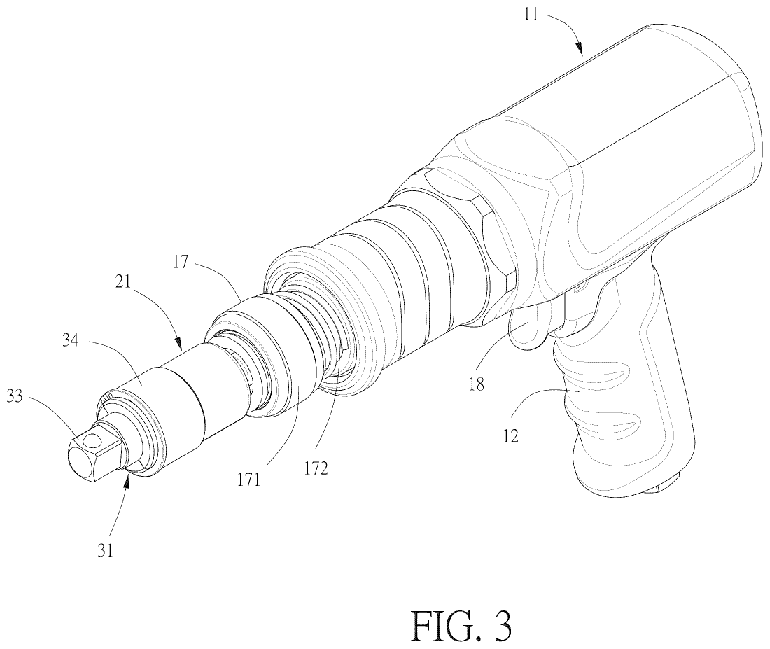

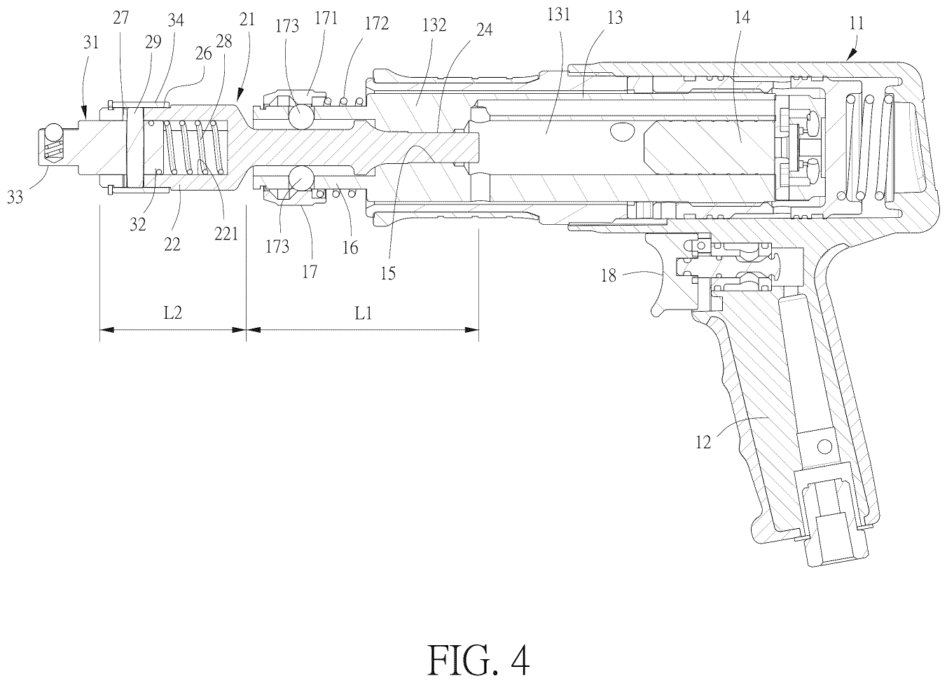

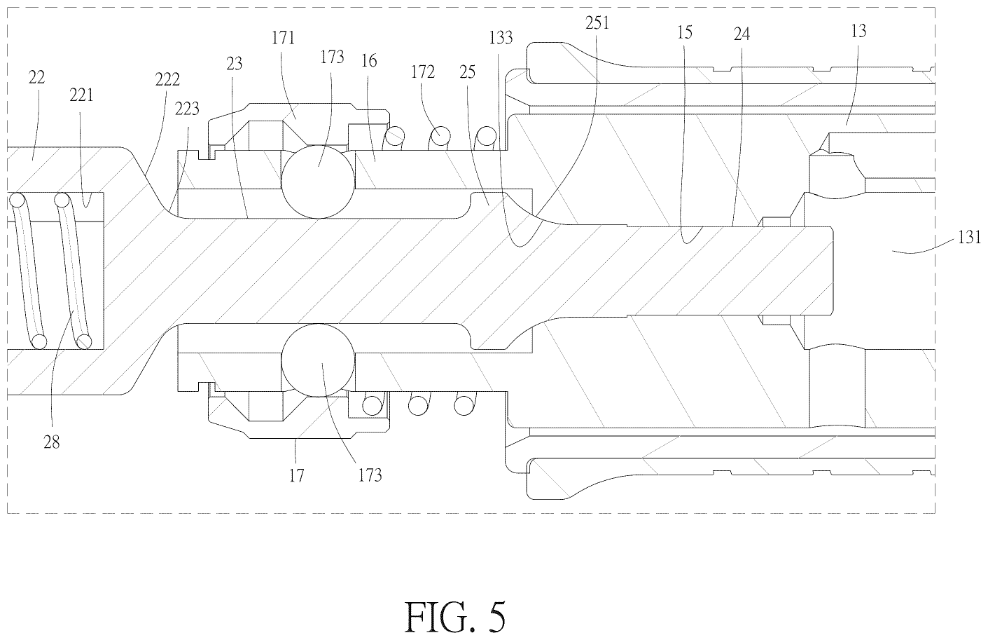

Referring to FIG. 1 through FIG. 5, an impact tool assembly provided by the present invention comprises a power-driven impact tool 11, a connector 21, and a tool head 31.

The power-driven impact tool 11 has a grip 12 and an inner tubular member 13 on top of the grip 12. In this embodiment, the grip 12 is in the shape of a pistol. A chamber 131 is formed inside the inner tubular member 13. An impact block 14 is provided in the chamber 131. The impact block 14 is driven by compressed air to move back and forth in the chamber 131. The operation of the impact block 14 is a common technique and is not the feature of the present invention, so it will not be described hereinafter. The inner tubular member 13 has a front end 132. The front end 132 has a positioning hole 15 communicating with the chamber 131. The inner edge of the positioning hole 15 is non-circular and has at least one engaging surface 151. In this embodiment, the positioning hole 15 is a hexagonal hole and has six engaging surfaces 151. The front end 132 of the inner tubular member 13 has a socket 16. In this embodiment, the socket 16 is integrally formed with the front end 132 of the inner tubular member 13. The socket 16 is in the form of a hollow tube extending out of the grip 12. A connecting portion 17 is provided on the periphery of the socket 16. The connecting portion 17 is composed of a quick-release joint. The connecting portion 17 in the form of a quick-release joint includes a collar 171, a return spring 172 for pushing the collar 171, and a plurality of beads 173 located in the collar 171 and partially extending into the socket 16.

The connector 21 has one end formed with an enlarged coupling portion 22 in the form of a sleeve. An accommodating groove 221 having an opening is defined in the coupling portion 22. The other end of the connector 21 is integrally formed with an extension section 23 and an insertion section 24 that extend in a direction opposite to the coupling portion 22 and have a smaller outer diameter. The ratio of the outer diameters of the coupling portion 22, the extension section 23 and the insertion section 24 is approximately 2:1:0.8 for reducing the weight of the connector 21. An annular slope 222 is integrally connected between the coupling portion 22 and the extension section 23. The annular slope 222 gradually tapers toward the extension section 23. Through the configuration of the annular slope 222, the wall thickness between the coupling portion 22 and the extension section 23 is increased, so as to enhance the structural strength and resistance to vibration. A circular curved section 223 is formed at the intersection of the annular slope 222 and the extension section 23. The circular curved section 223 provides excellent stress dispersion and prevents breakage due to severe vibration. An enlarged annular flange 25 is integrally formed between the extension section 23 and the insertion section 24. The insertion section 24 of the connector 21 is inserted into the positioning hole 15. The extension section 23 is inserted into the socket 16. The periphery of the insertion section 24 corresponds in shape to the positioning hole, thereby restricting the connector 21 from radial rotation. In this embodiment, the insertion section 24 is formed by directly cutting the periphery of a round rod 241 to form six flat surfaces 242 conforming to the shape of the inner edge of the positioning hole 15. In order to ensure the stability of the center of gravity of the connector 21 after assembly, the total length L1 of the extension section 23 and the insertion section 24 is greater than the length L2 of the coupling portion 22. When the insertion section 24 of the connector 21 is inserted into the positioning hole 15, the insertion section 24 and the extension section 23 are held and supported by the positioning hole 15 and the beads 173 of the connecting portion 17, respectively, thereby effectively reducing the shaking of the insertion section 24 and the extension section 23 of the connector 21 to ensure the reliability of the transmission. Besides, when the insertion section 24 of the connector 21 is inserted into the positioning hole 15, the distal end of the insertion section 24 extends into the chamber 131 of the inner tubular member 13. One side of the annular flange 25, facing the positioning hole 15, has a curved surface 251. An inner peripheral wall 133 is formed between the socket 16 and the positioning hole 15 and corresponds in shape to the curved surface 251. The curved surface 251 leans against the inner peripheral wall 133, which provides a restricting function when the connector 21 is returned and ensures the straightness after the connector 21 is returned, so that the center of the connector 21 is aligned with the axis of the chamber 131.

The tool head 31 is rotatably connected in the accommodating groove 221 of the coupling portion 22. The tool head 31 has a body portion 32 inserted in the accommodating groove 221 and a head portion 33 exposed outside the accommodating groove 221. The head portion 33 is in the form of a quadrangular post for connecting a socket bit (not shown). In this embodiment, the coupling portion 22 has an annular recess section 26 having a smaller outer diameter. Two opposite sides of the annular recess section 26 each have a V-shaped inclined groove 27 communicating with the accommodating groove 221. A spring 28 is provided in the accommodating groove 221. Two ends of the spring 28 are against the bottom of the accommodating groove 221 and the body portion 32 of the tool head 31, respectively, for pushing the tool head 31. A pin 29 is inserted into the body portion 32 of the tool head 31 via the inclined groove 27 of the coupling portion 22. Both ends of the pin 29 are inserted into the inclined grooves 27 of the two opposite sides of the annular recess section 26 of the coupling portion 22, respectively. A bushing 34 is fitted on the annular recess section 26 to cover the inclined grooves 27 and the pin 29, so as to prevent the pin 29 from falling out of the inclined grooves 27. The assembly of the present invention is completed.

In actual use, when it is necessary to disassemble a threaded element (such as a nut) that is difficult to unscrew, a socket bit with an appropriate size is first mounted on the head portion 33 of the tool head 31, and then the socket bit is attached to the threaded element. After that, by pressing the button 18 on the grip 12, compressed air is introduced to the chamber 131 of the inner tubular member 13 for pushing the impact block 14 to hit the distal end of the insertion section 24 of the connector 21 extending into the chamber 131 at high speed. At this time, the insertion section 24 is engaged with the positioning hole 15 to restrict the radial rotation of the connector 21, so that the connector 21 can only move forward in its axial direction, thus ensuring that the impact force can be fully delivered. When the connector 21 moves forward, the spring 28 is relatively compressed to force the tool head 31 to retract, so that the pin 29 slides along the inclined grooves 27, thereby driving the tool head 31 and the socket bit mounted on the tool head 31 to rotate together. The vibration generated by the impact block 14 is completely transmitted to the threaded element. In this way, it is easy to rotate and remove the threaded element that is tightly stuck on the workpiece.

In the present invention, the front end 132 of the inner tubular member 13 of the power-driven impact tool 11 has the positioning hole 15 communicating with the chamber 131, and the engaging surfaces 151 on the inner edge of the positioning hole 15 are engaged with the insertion section 24 of the connector 21. In this way, the connector 21 can be directly mounted on the power-driven impact tool 11 without changing the internal mechanism of the power-driven impact tool 11. Furthermore, because the outer diameter of the coupling portion 22 is greater than that of the extension section 23 and the insertion section 24 and the coupling portion 22 mounted with the tool head 31 is heavier, in order to ensure the stability of the center of gravity of the connector 21 after assembly, the total length L1 of the extension section 23 and the insertion section 24 is greater than the length L2 of the coupling portion 22. When the insertion section 24 and the extension section 23 in of the connector 21 are inserted into the inner tubular member 13, they are held and supported by the positioning hole 15 and the beads 173 of the connecting portion 17, respectively. Besides, the annular slope 222 and the circular curved section 223 integrally connected between the coupling portion 22 and the extension section 23 are configured to provide additional stress dispersion, which can effectively reduce the shaking caused by the impact and ensure the reliability of the transmission. In the present invention, the tool head is driven by the power-driven impact tool 11, having high force output and extremely high work efficiency.

Furthermore, the present invention uses an external power source, such as compressed air in this embodiment, to drive the impact block 14 for performing the hitting action. Therefore, it not only eliminates the physical exertion of hammering with a hand-held hammer but also effectively solves the problem of injuries caused by manual hammering that is easy to hit the user's hand accidentally. The present invention is practical.

What is claimed is:

1. An impact tool assembly, comprising:
a power-driven impact tool, having a grip, the grip having an inner tubular member therein, a chamber being formed inside the inner tubular member, an impact block being provided in the chamber, the impact block being driven by an external power to move back and forth in the chamber, one end of the inner tubular member having a hexagonal positioning hole communicating with the chamber, the positioning hole being non-circular and having six engaging surfaces;
a connector, having one end formed with an enlarged coupling portion and another end integrally formed with an extension section and an insertion section that extend in a direction opposite to the coupling portion and have an outer diameter less than that of the coupling portion, an annular slope being integrally connected between the coupling portion and the extension section, the annular slope gradually tapering toward the extension section, a circular curved section being formed at an intersection of the annular slope and the extension section, a total length of the extension section and the insertion section being greater than a length of the coupling portion, the insertion section of the connector being inserted into the positioning hole, the insertion section being a hexagonal post corresponding in shape to the positioning hole, thereby restricting the connector from rotating;
a tool head, rotatably connected to the coupling portion, the tool head having a head portion extending out of the coupling portion, the head portion being in the form of a quadrangular post for connecting a socket bit, the coupling portion being expanded outward to form an accommodating groove therein, the accommodating groove having an opening, the tool head further having a body portion inserted in the accommodating groove, the coupling portion having an annular recess section, two opposite sides of the annular recess section each having an inclined groove, a spring being provided in the accommodating groove, two ends of the spring being against a bottom of the accommodating groove and the body portion of the tool head respectively for pushing the tool head, a pin being inserted into the body portion of the tool head via the inclined groove of the coupling portion, two ends of the pin being inserted in the inclined grooves of the two opposite sides of the annular recess section of the coupling portion respectively, a bushing being fitted on the annular recess section to cover the inclined grooves and the pin.

2. The impact tool assembly as claimed in claim 1, wherein a front end of the inner tubular member has a socket, when the insertion section of the connector is inserted into the positioning hole, the extension section is inserted into the socket, and the socket has a connecting portion that is in contact with the extension section.

3. The impact tool assembly as claimed in claim 2, wherein the socket is integrally formed with the front end of the inner tubular member, the socket is in the form of a hollow tube extending out of the grip, the connecting portion is composed of a quick-release joint, the connecting portion includes a collar and a plurality of beads located in the collar and partially extending into the socket, and the insertion section and the extension section are held and supported by the positioning hole and the beads of the connecting portion, respectively.

4. The impact tool assembly as claimed in claim 1, wherein an enlarged annular flange is integrally formed between the extension section and the insertion section, when the insertion section of the connector is inserted into the positioning hole, a distal end of the insertion section extends into the chamber of the inner tubular member, and the annular flange leans against an inner peripheral wall of the inner tubular member.

5. The impact tool assembly as claimed in claim 1, wherein the inclined grooves of the two opposite sides of the annular recess section of the coupling portion are V-shaped grooves.
